(19) United States
(12) Patent Application Publication
(10) Pub. No.: US 2009/0218534 A1
(43) Pub. Date: Sep. 3, 2009

(54) Carburettors

(76) Inventor: Stephen Brian Glover, County Kerry (IE)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/064,354

(22) PCT Filed: Aug. 23, 2006
(86) PCT No.: PCT/GB06/03152

§ 371 Date: Oct. 8, 2008

(30) Foreign Application Priority Data
Aug. 23, 2005 (GB) 0517236.6

(51) Int. Cl. F16K 1/22

(52) U.S. Cl. 251/305

(57) ABSTRACT

A carburettor for a two-stroke engine includes a substantially circular section flow duct comprising rich (42) and lean (44) flow passages in parallel, through which, in use, air flows in a flow direction and which are separated by a substantially planar partition (66). At least one fuel jet (60, 61, 62) communicates with the rich passage (42) and the partition (66) includes an aperture (68) towards which the fuel jet is directed. A substantially planar butterfly valve (20) is received in the aperture (68) so as to be pivotable between a first position, in which the flow duct is substantially closed, and a second position, in which the flow duct is substantially open. The butterfly valve (20) is carried by a pivotal shaft (2) mounted to pivot about an axis which extends through the flow duct substantially diametrically. The butterfly valve (20) is connected to the pivotal shaft (2) such that, when it is in the second position, its plane is parallel to the diametral plane in which the said axis lies but is offset from it in a direction towards the rich passage. The plane of the planar partition (66) is also parallel to the said diametral plane but offset from it in a direction towards the rich passage. The cross-sectional area of the lean flow passage is therefore greater than that of the rich flow passage.

The present invention relates to carburettors of the type disclosed in WO99/58829. Such carburettors are intended for use with two-stroke engines whose inlet duct is divided into two separate passages, referred to as a rich passage and a lean passage. The carburettor is arranged to direct a rich fuel/air mixture into the rich passage and a weak mixture or substantially pure air into the lean passage at high engine load, when the carburettor butterfly valve is substantially fully open. At low engine load, when the butterfly valve is substantially closed, the carburettor may direct a substantially equally rich mixture into both the rich and lean passages, if the engine is a very small one and with somewhat larger engines it may direct a weak mixture or substantially pure air into the lean passage and a rich fuel/air mixture into the rich passage.

The engine with which the carburettor is used is of the crankcase scavenged type and is arranged so that the combustion space is filled with a stratified charge, that is to say a charge whose fuel/air ratio varies over the volume of the combustion space, at least at high engine load. This is achieved in the engine disclosed in WO99/58829 by dividing the interior of the crankcase into two or more separate volumes, one of which, referred to as the rich volume, communicates with the rich passage, and the other of which, referred to as the lean volume, communicates with the lean passage. The rich and lean volumes communicate with the combustion space at different positions. In the engine disclosed in this prior document, the combustion space is filled with a substantially homogeneous charge at low engine load, that is to say a charge whose fuel/air ratio is substantially the same over the volume of the combustion space.

Under high engine load, the combustion space is scavenged primarily with substantially pure air from the lean volume. The remaining pure air and the rich fuel/air mixture from the rich volume do not mix thoroughly and the charge is stratified. Under low load, there is a similar relatively weak fuel/air mixture in both the rich and lean volumes and the charge in the combustion space is therefore substantially homogeneous.

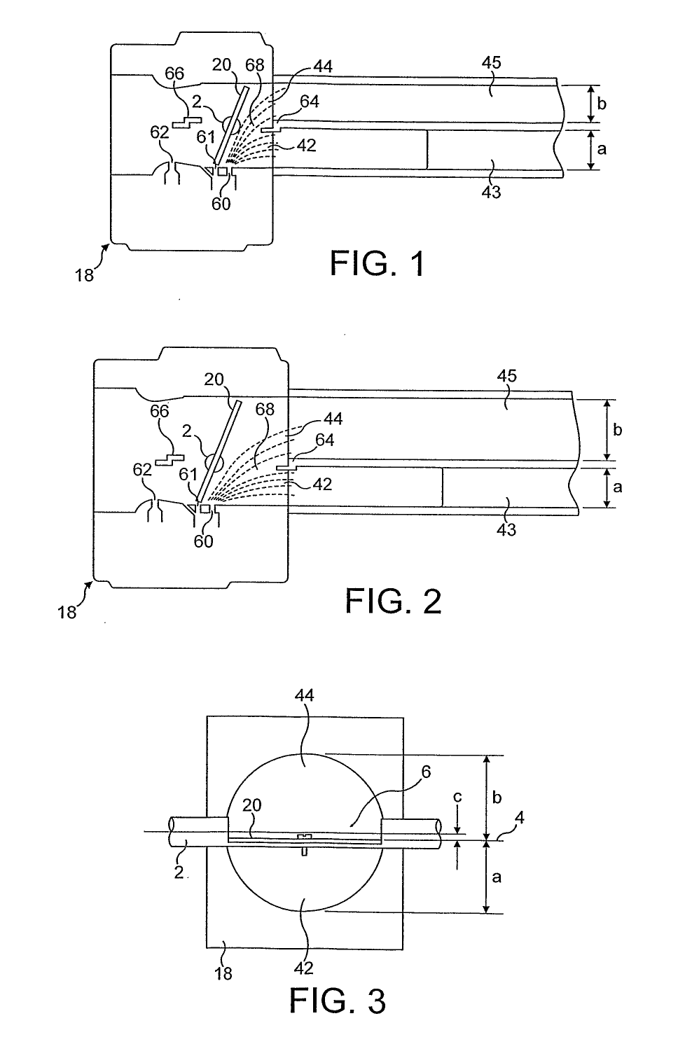

The carburettor disclosed in WO99/58829 is shown highly schematically in FIG. 1. The carburettor 18 includes a flow duct comprising rich 42 and lean 44 flow passages in parallel, through which, in use, air flows in a flow direction and which are separated by a substantially planar partition 66. A number of fuel jets 60, 61, 62 communicate with the rich passage 42. The partition 30 includes an aperture 68 towards which the fuel jets are directed and a substantially planar butterfly valve 20 is received in the aperture 68 so as to be pivotable between a first position, in which the flow duct is substantially closed and the aperture 68 is substantially open, and a second position, in which the flow duct is substantially open and the aperture 68 is substantially closed. The carburettor is connected to the inlet duct of an engine which is divided by a substantially planar portion 64 into a rich duct 43 and a lean duct 45, which communicate with the rich and lean passages 42, 44, respectively.

The flow duct in the carburettor is of circular section and the pivotal shaft 2 carrying the planar valve 20 necessarily extends diametrically since otherwise the valve 20 would become jammed and/or would be unable to adequately seal the flow duct. This means that the cross-sectional areas of the rich and lean passages are therefore the same. The heights a and b of these two passages are therefore the same.

It has, however, been found that the carburettor described above is not capable of supplying sufficient air to satisfy the requirement of certain engines, when running under full load, that is to say that in certain engines the ratio of the flow rates through the lean and rich passages is insufficient to achieve optimum operation.

It is therefore the object of the invention to provide a carburettor of the type referred to above which will inherently provide a greater proportion substantially pure air, that is to say a higher ratio of the flow rates through the lean and rich passages but is nevertheless no larger than the known carburettor.

According to the present invention there is provided a carburettor for a two-stroke engine including a substantially circular section flow duct comprising rich and lean flow passages in parallel, through which, in use, air flows in a flow direction and which are separated by a substantially planar partition, at least one fuel jet communicating with the rich passage, the partition including an aperture towards which the fuel jet is directed, and a substantially planar butterfly valve being received in the aperture so as to be pivotable between a first position, in which the flow duct is substantially closed and the aperture is substantially open, and a second position, in which the flow duct is substantially open and the aperture is substantially closed, the butterfly valve being carried by a pivotal shaft mounted to pivot about an axis which extends through the flow duct substantially diametrically, characterised in that the butterfly valve is connected to the pivotal shaft such that, when it is in the second position, its plane is parallel to the diametral plane in which the second axis lies but is offset from it in the direction towards the rich passage and that the plane of the planar partition is parallel to the said diametral plane but is offset from it in the direction towards the rich passage, whereby the cross-sectional area of the lean flow passage is greater than that of the rich flow passage.

The carburettor in accordance with the invention is thus generally the same as that described in WO99/58829 but the butterfly valve is not connected symmetrically to the pivotal shaft such that its plane passes through the pivotal axis, as previously, but is connected to it asymmetrically such that its plane is offset from the pivotal axis, when it is in the second position and the flow duct is open. The planar partition is also offset from a diametral plane in the same direction and by the same distance. The result of this is that the cross-sectional area of the rich passage is less than that of the lean passage and thus that, in use, the ratio of the volumetric flow rate of air through the lean passage to that of air/fuel mixture through the rich passage is increased. However, the axis of rotation of the butterfly valve still lies in a diametral plane so that the butterfly valve can still move freely and close the flow duct. The overall size of the carburettor is no greater than before.

In practice, the cross-sectional area of the lean passage will be at least 10% greater than that of the rich passage and it is preferred that it is 20% to 40% greater, particularly 25% to 35% greater.

The diameter of the pivotal shaft is generally quite small and the distance by which the butterfly valve must be offset from the pivotal axis in order to obtain the difference in the cross-sectional areas of the rich and lean passages referred to above is likely to be greater than the radius of the conventional pivotal shaft. For this reason, the diameter of the pivotal shaft in the carburettor in accordance with the present invention will in practice be significantly larger than the diameter of the pivotal shaft in the prior document referred to above. However, if the pivotal shaft were circular over its entire length, this would mean that it would extend a significant distance into the lean passage. This would result in a considerable throttling effect and in the production of considerable turbulence in the lean passage, which is highly undesirable. In order to avoid this, it is preferred that the pivotal shaft is of circular section and that portion of it which extends through the flow duct is provided with a flat on the side opposite to the offset direction extending parallel to the plane of the butterfly valve, whereby the pivotal shaft does not extend substantially into the lean passage.

Further features and details of the invention will be apparent from the following description of one specific embodiment of carburettor in accordance with the invention, which is given by way of example only with reference to FIGS. 2 and 3 of the accompanying drawings, in which:

FIG. 2 is a highly diagrammatic longitudinal sectional view similar to FIG. 1; and

FIG. 3 is a transverse sectional view of the carburettor shown in FIG. 2.

The carburettor shown in FIGS. 2 and 3 is very similar to that described in relation to FIG. 1 and its construction and operation will therefore not be described in detail. It differs from that shown in FIG. 1 in that the pivotal shaft is of considerably greater diameter and the butterfly valve 20 is connected to it offset from its axis of rotation 4 by a distance c. When the valve is in the fully open position shown in FIG. 3, the butterfly valve 20 therefore extends parallel to a diametral plane in which the axis of rotation 4 lies, but offset from it by the distance c towards the rich passage 42. The planar partition 66 is also offset from the diametral plane in the same direction and by the same distance. The height b of the lean passage is therefore greater than the height a of the rich passage and it will be clear that b=a+2c. The cross-sectional area of the lean passage is therefore greater than that of the rich passage and the flow rate of air through it is, in use, therefore greater than through the rich passage.

As may be see in FIG. 3, in order to ensure that the pivotal shaft 2 does not extend substantially into the lean passage 44 and thus cause undesirable throttling and turbulence, it is cut away in the region 6 on the side opposite to the direction of offset over that portion of its length which extends through the flow duct. It is thus provided with a flat extending parallel to the diametral plane against which the butterfly valve is connected.

In use, the carburettor is connected to the inlet duct of a two-stroke engine and this duct is of course divided into rich and lean ducts 43, 45 by a partition 64. This partition is also offset by a distance c and is thus contiguous with the partition 66.

1. A carburettor for a two-stroke engine including a substantially circular section flow duct comprising rich and lean flow passages in parallel, through which, in use, air flows in a flow direction and which are separated by a substantially planar partition, at least one fuel jet communicating with the rich passage, the partition including an aperture towards which the fuel jet is directed, and a substantially planar butterfly valve being received in the aperture so as to be pivotable between a first position, in which the flow duct is substantially closed and the aperture is substantially open, and a second position, in which the flow duct is substantially open and the aperture is substantially closed, the butterfly valve being carried by a pivotal shaft mounted to pivot about an axis which extends through the flow duct substantially diametrically, characterised in that the butterfly valve is connected to the pivotal shaft such that, when it is in the second position, its plane is parallel to the diametral plane in which the second axis lies but is offset from it in the direction towards the rich passage and that the plane of the planar partition is parallel to the said diametral plane but is offset from it in the direction towards the rich passage, whereby the dross-sectional area of the lean flow passage is greater than that of the rich flow passage.

2. A carburettor as claimed in claim 1 in which the cross-sectional area of the lean flow passage is 20 to 40% larger than that of the rich flow passage.

3. A carburettor as claimed in claim 1 in which the pivotal shaft is of circular section and that portion of it which extends through the flow duct is provided with a flat on the side opposite to the offset direction extending parallel to the plane of the butterfly valve, whereby the pivotal shaft does not extend substantially into the lean passage.

4. A carburettor as claimed in claim 2 in which the pivotal shaft is of circular section and that portion of it which extends through the flow duct is provided with a flat on the side opposite to the offset direction extending parallel to the plane of the butterfly valve, whereby the pivotal shaft does not extend substantially into the lean passage.
